(19) United States
(12) Patent Application Publication
(10) Pub. No.: US 2008/0058993 A1
(43) Pub. Date: Mar. 6, 2008

(54) System, Methods, Apparatuses and Computer Program Products for Use on a Machine Tool Controller

(75) Inventors: Robert Tain, Charlotte, NC (US); Brian Sides, Waxhaw, NC (US); Bryan Newman, Rock Hill, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Okuma America Corporation

(21) Appl. No.: 11/850,359

(22) Filed: Sep. 5, 2007

Related U.S. Application Data
(60) Provisional application No. 60/824,508, filed on Sep. 5, 2006.

(51) Int. Cl. G05B 15/00

(52) U.S. Cl. 700/275; 705/1

(57) ABSTRACT

A method for providing a machine tool controller capable of “plug 'n play” operation with partner devices includes providing an application programming interface (API) capable of executing software associated with at least one partner device, providing a machine tool controller configured to run the API, and enabling communication between the machine tool controller and the at least one partner device over a network enabled by the API.

### CROSS REFERENCE TO RELATED APPLICATION

This application claims the benefit of U.S. Provisional Application No. 60/824,508, filed Sep. 5, 2006, the contents of which are incorporated herein in their entirety.

### FIELD OF THE INVENTION

Embodiments of the present invention relate generally to device control technology, and more particularly, to providing a controller capable of “plug 'n play” operation with partner devices and associated applications for machine tools.

### BACKGROUND OF THE INVENTION

Many organizations have taken a strong interest in increasing organizational productivity. Such increases are achieved in numerous ways including streamlining procedures, improving equipment, improving worker training, improving safety, reducing waste, reducing downtime, etc. As an example, in the manufacturing industry, many organizations have increasingly turned to automation of production. As technology continues to advance, manufacturing equipment has become increasingly precise and reliable with the advent of sophisticated control systems. Accordingly, many manufacturers have filled their factory floors with production chain equipment that includes numerous sophisticated machines, many of which operate under the control of dedicated controllers.

Using such sophisticated machines, manufacturers have been enabled to produce higher quality products at reduced costs once the production chains are established. However, the production chains often include sophisticated machines from various different machine building companies or vendors. For example, a machine tool made by one vendor may be fed stock and subsequently unloaded by a robot made by another vendor. The robot may then feed the machined stock to a precise measurement device made by yet another vendor to ensure the machined stock is within standards. In the past, if it was desired that each of the machines above operate without a corresponding operator stationed at the machine, it would be necessary to install a complex network for communication between the machines. Since each of the machines may be manufactured by a different machine building company, although each machine may be capable of local control via a computer, the connections between each machine could be very complex. For example, numerous expensive and customized cables and/or custom converters may be required to establish an interface between each of the machines in order to enable them to operate seamlessly. As a result, when a new machine is added to a production chain, significant overhead may be involved in providing integration of the new machine. Additionally, business practices of many machine vendors have developed proprietary practices that limit a manufacturer's ability to upgrade machines or utilize software or hardware from other machine builders.

Due to the increased overhead, delays and complexity involved with integration of new machines, a demand has arisen for an easier mechanism by which machine integration on the factory floor may be accomplished. Additionally, there has been a desire to eliminate the inefficiencies caused by the proprietary practices of machine vendors. Thus, for example, manufacturers have created a demand for a “plug 'n play” factory floor environment where each machine or device is capable of a simple connection and low overhead installation regardless of which machine vendor produced the machine or device. As used herein, plug 'n play capability should be understood to refer to a feature that allows the addition of a new type of device without requiring reconfiguration or extensive laborious installation of device drivers. As such, it should be understood that plug 'n play capability implies both hardware and software compatibility for plug 'n play operation with new software or devices. Additionally, there is also a demand for applications which may utilize the improved integration of machines on the factory floor. More specifically, there is a demand to move away from proprietary hardware and software that are not easily connected.

### BRIEF SUMMARY OF THE INVENTION

Accordingly, in order to address the problems described above, embodiments of the present invention provide methods, apparatuses and computer program products for providing a controller, such as a machine tool controller, capable of “plug 'n play” operation with partner devices and associated applications. In this regard, the machine tool controller of embodiments of the present invention is capable of recognizing newly installed partner devices and establishing communications with the partner devices automatically. Accordingly, for example, communication between a machine tool employing the machine tool controller and the partner devices may be accomplished with relatively low overhead and delay. Additionally, the capabilities of the machine tool may be continuously upgraded via installation of applications for enhancing machine tool operation. Such applications could be developed by any source including, for example, external vendors or even users themselves. Thus, embodiments of the present invention provide an open architecture by which software and devices may be added to machine tool systems regardless of the origin of the software and devices to be added.

In one exemplary embodiment, a method for providing a machine tool controller capable of “plug 'n play” operation with partner devices is provided. The method includes providing an application programming interface (API) capable of executing software associated with at least one partner device, providing a machine tool controller configured to run the API, and enabling communication between the machine tool controller and the at least one partner device over a network enabled by the API.

In another exemplary embodiment, a computer program product for providing a machine tool controller capable of “plug 'n play” operation with partner devices is provided. The computer program product includes at least one computer-readable storage medium having computer-readable program code portions stored therein. The computer-readable program code portions include first, second and third executable portions. The first executable portion is for providing an application programming interface (API) capable of executing software associated with at least one partner device. The second executable portion is for providing a machine tool controller configured to run the API. The third executable portion is for enabling communication between the machine tool controller and the at least one partner device over a network enabled by the API.

In another exemplary embodiment, a machine tool comprising a machine tool controller is provided that is capable of executing the computer program product above and providing remote monitoring functions. Thus, for example, a machine tool controller may be configured to provide plug 'n play operation with partner devices and to provide remote system protection monitoring. In an exemplary embodiment, the machine tool controller may include a processing element configured to provide an application programming interface (API) capable of communicating with software associated with at least one partner device, provide a machine tool controller configured to run the API, and enable communication between the machine tool controller and the at least one partner device over a network enabled by the API.

In yet another exemplary embodiment, a business method is provided. The method includes providing an API having an open architecture onto a machine tool controller. The machine tool controller is installed on a machine tool. The API is then distributed to a customer at no charge when the customer purchases the machine tool.

Some embodiments of the invention provide an increased ability to manage machine tool operation, including remote management. Embodiments of the invention may also provide improved communication between partner devices. As a result, organizational productivity may be enhanced.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram illustrating a system for providing a controller, such as a machine tool controller, capable of “plug 'n play” operation with partner devices and executing associated applications according to an exemplary embodiment of the present invention;

FIG. 2 illustrates an example of a web page associated with a partner device displayed on a machine tool according to an exemplary embodiment of the present invention;

FIG. 3 shows an example of a machine tool and partner devices according to an exemplary embodiment of the present invention;

FIG. 4 shows an example of a machine tool and other partner devices according to another exemplary embodiment of the present invention;

FIG. 5 illustrates a display interface which may be rendered at a display of the machine tool via communication with a gauge according to an exemplary embodiment of the present invention;

FIG. 6 illustrates a screen capture of a setup wizard application according to an exemplary embodiment of the present invention;

FIG. 7 shows a flowchart of a system and method for providing a controller capable of “plug 'n play” operation with partner devices and associated applications according to an exemplary embodiment of the present invention; and

FIG. 8 shows a flowchart of a system and method for providing a machine tool controller according to an exemplary embodiment of the present invention.

### DETAILED DESCRIPTION OF THE INVENTION

Embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As background, it should be understood that embodiments of the present application are designed to be implemented to enable the integration of multiple partner devices into a communication network especially for use in the machine tool industry where many peripheral partner devices work most efficiently when communicating directly with a machine tool.

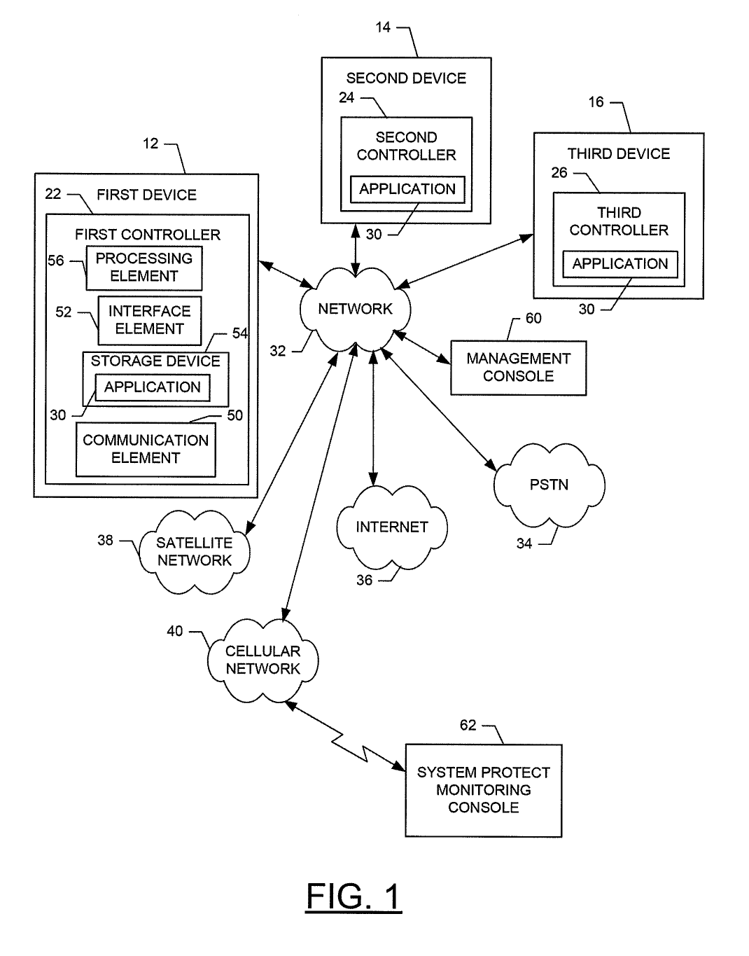

FIG. 1 is a diagram illustrating a system 10 for providing a controller, such as a machine tool controller, capable of “plug 'n play” operation with partner devices and executing associated applications. As shown in FIG. 1, the system 10 includes a plurality of devices such as a first device 12, a second device 14 and a third device 16. In an exemplary embodiment, the first device 12 may be a machine tool and the second and third devices 14 and 16 may be any partner devices capable of communication with the first device 12. Each of the first, second and third devices 12, 14 and 16 may operate under the control of a corresponding controller (i.e., a first controller 22, a second controller 24, and a third controller 26, respectively). The first, second and third controllers 22, 24 and 26 may each include a processing element capable of executing instructions for directing the operations of the corresponding first, second and third devices 12, 14 and 16, respectively. Additionally, each of the first, second and third controllers 22, 24 and 26 may be capable of executing an application 30. In an exemplary embodiment, the first, second and third controllers 22, 24 and 26 may each be in communication with each other via a network 32.

It should be understood that although FIG. 1 shows three devices, any number of devices could be included in the system 10. Additionally, it should be understood that the processing elements described above may be embodied in many ways. For example, the processing elements may be embodied as any of a processor, a coprocessor, a controller or various other processing means or devices including integrated circuits such as, for example, an ASIC (application specific integrated circuit). In an exemplary embodiment, one or more of the controllers may be embodied as a personal computer based controller. Thus, for example, the controller may run an operating system such as Windows XP or any other known operating system and may employ standard memory and peripheral devices associated with a personal computer. In an exemplary embodiment, the controller may include at least 40 GB of hard drive space and a robust processing element in order to ensure single processor operation without a need to call numerous subprograms. It should also be understood that the application 30 could be different on each corresponding controller. Additionally, the application 30 could be either stored locally at each corresponding controller or otherwise be accessible to a respective controller. Additionally, it should be understood that although only the first controller 22 will be described in detail below, each of the other controllers could include similar functionality to that described herein with reference to the first controller 22. Furthermore, functions described herein as being associated with the first controller 22, which in an exemplary embodiment is a machine tool controller, may also be performed by a controller or other processing element that is located elsewhere within the network 32.

The network 32 may be any communication backbone known in the art. For example, the network 32 could be very simple, such as only including the first, second and third devices 12, 14 and 16, or the network could be complex including a server and/or links to external public or private networks such as either wired or wireless networks including, for example, cellular or satellite communication networks. In an exemplary embodiment, as shown in FIG. 1, the network 32 may be a private or local area network (LAN), such as an Ethernet, in communication with any or all of a public switched telephone network (PSTN) 34, the Internet 36, a satellite network 38, a cellular communication network 40 and other suitable networks. In an exemplary embodiment, the network 32 may be a device network bridge. Accordingly, the need for large numbers of wires to connect each of various different devices that was experienced with conventional attempts to network devices may be eliminated by the use of a single cable (although emergency stop wiring may also be employed). In one exemplary embodiment, TCP/IP (Transmission Control Protocol/Internet Protocol) communications may be conducted between each of the devices.

The first controller 22 (i.e., the machine tool controller) may include, for example, a communication element 50, an interface element 52 and a storage device 54, all of which may operate under the control of a processing element 56 having characteristics similar to those described above. The first controller 22 comprises an application programming interface (API) which enables the first controller 22 to be open to communication with devices that may have different protocols for communication or which may have different formats for storing information in response to which other devices may be capable of modifying their corresponding operations. As such, the API of the first controller 22 enables the first device 12 to act as an open or fluid platform capable of plug 'n play operation with devices a user may choose to install that may not be made by the same company as the first device 12. Additionally, since the first device 12 is enabled to act as an open or fluid platform, the API of the first controller 22 may enable the first controller 22 to execute any additional software the user may choose to install at the first controller 22 without imposing additional requirements on the user. Moreover, the user may add peripheral devices or program unique software for utilization with the first controller 22, and the open architecture of the API enables seamless incorporation of such devices or software.

It should be noted that the API may be offered as a free inherent feature of each machine tool. Accordingly, a business practice of providing a machine tool having a free API with an open architecture may be utilized in order to provide customers with plug 'n play capability on the factory floor. As such, enterprise resource (EPR) management may be achieved since the factory floor may not be limited to function as “islands of automation”.

The storage device 54 of the first controller 22 may be any volatile or non-volatile storage device known in the art. The communication element 50 may be embodied as any device or means embodied in either hardware, software, or a combination of hardware and software that is capable of performing the corresponding functions associated with the communication element 50 as described below. The interface element 52 may include functional elements for enabling a user to input, view, modify or edit information. As such, the interface element 52 may include the capability of communicating with input devices such as, for example, a keypad, keyboard, mouse, touch screen display, barcode reader, RFID tag reader, or any other suitable input device and output devices including any of a display, a printer, a speaker, a facsimile, etc.

The communication element 50 may be capable of communicating with partner devices (i.e., the second and third devices 14 and 16) via the network 32. The communication element 50 may also enable the first device 12 to communicate with other devices in communication with the network 32 such as, for example, a management console 60. The communication element 50 may also enable the first device 12 to communicate with other devices external to the network 32 such as, for example, a system protect monitoring console 62. The management console 60, may be in communication with each device on the network 32 to monitor operation of the first device 12 and each partner device. In an exemplary embodiment, each of the first, second and third devices 12, 14 and 16 and the management console 60 (i.e., every device on the network 32) may have a corresponding IP address to permit communication between each of the devices.

In this regard, the management console 60 may collect operational status information such as operating parameters for analysis, storage, display, and/or communication to other entities. As such, in an exemplary embodiment, the management console 60 could serve as a central location for management of the operations of every device on the network 32. Either the management console 60 or the first device 12 may execute user selected applications such as the application 30. The application 30 could be, for example, an application developed by the manufacturer of the first device 12, or any other software developer including the user. As such, the system 10 is not proprietary in the sense that there is no requirement for a user to purchase software or hardware from any particular vendor. Rather, by utilizing the open architecture of the API, each partner producing a device (e.g., a partner device) within the system and/or the user may develop applications to suit their own purposes.

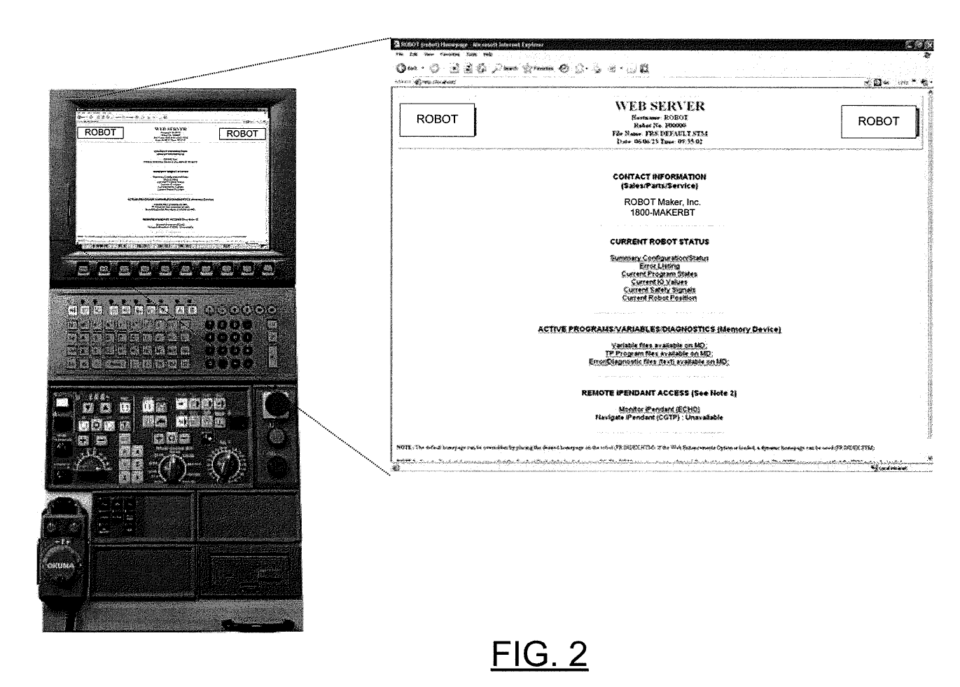

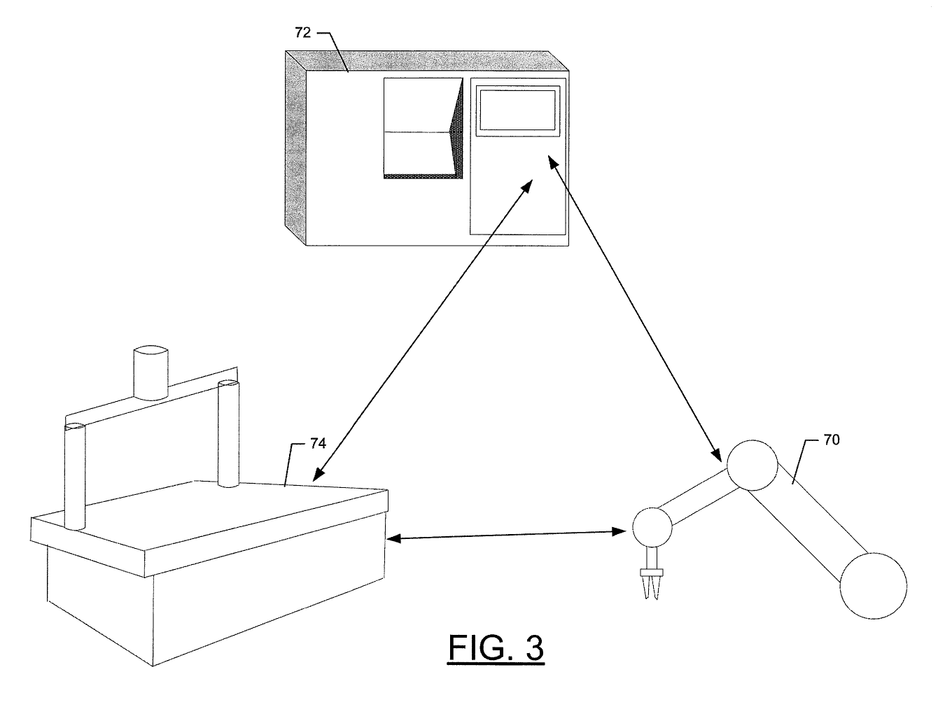

It should be understood that, as used herein, the term “partner device” should be construed as referring to any device with which the first processor 22 is capable of communication via the network 32 in a plug 'n play environment. As such, it should be understood that the communication element 50 of the first device 12, is capable of communication with each other partner device via a corresponding communication element in which, for example, based upon known properties of the partner device, dissimilar protocols and formats may be translated by corresponding communication elements to enable seamless communication between the first device 12 and the partner devices. Communication between the communication element 50 of the first device 12 and corresponding communication elements in other partner devices may be accomplished by any suitable means including, for example, Bluetooth communication. In an exemplary embodiment, the communication element 50 may be capable of detecting the presence of a new device on the network 32. For example, the communication element 50 may be capable of detecting the presence of the new device using a Bluetooth scan. In response to detection of the new device, the communication element 50 may be configured to determine whether or not the new device is “compatible” for plug 'n play operation. For example, the communication element 50 may query the new device for identification, in response to which, the new device may communicate identifying information (such as, for example, a model number, manufacturer ID, etc.). In an exemplary embodiment, the communication element 50 may look up the new device in a database of known devices to determine a proper communication protocol and/or proper communication format or translations to enable communication with the new device. Such a database may be routinely updated by manufacturers of the partner devices. Alternatively, in other embodiments, the communication element may interrogate the new device with each known communication protocol, communication format or translation in order to attempt to initiate communication. Additionally, in still other embodiments, other attempts may also be made to initiate communication with the new device. If the new device is compatible for plug 'n play operation, the first controller 22 may cause the first device 12 to display information (such as a pop up window or web page) indicating that the new device has been identified and that communication may be conducted with the new device as shown for example on FIG. 2, which illustrates a display of a device controller and a corresponding zoomed in view of a pop up window rendered on the display. The pop up window or web page may include status information regarding the new device or links to status information or other relevant information about the new device. FIG. 2, which illustrates the results of the above process, relates to FIG. 3.

As shown in FIG. 3, a robot 70 may be used to load and feed a machine tool 72 (i.e., the first device 12), such as a lathe, with stock. After the stock is machined by the machine tool 72, the machined stock may be unloaded by the robot 70 and transferred to a precise measurement tool 74, which measures the machined stock to determine whether the modified stock is within specifications. As such, it should be understood that the robot 70, the machine tool 72 and the precise measurement tool 74 are each in communication with each other via the network 32. In an exemplary embodiment, the machine tool 72 may include a barcode scanner in communication the interface element 52 (for example, via a USB connection, Bluetooth or the like). As such, the barcode scanner may scan a barcode corresponding to a particular job identifier. Alternatively, the job identifier may be manually entered or any other suitable means of entering the job identifier may be employed. A setup sheet or other corresponding program instructions associated with the job identifier may be displayed or otherwise indicated at the machine tool 72. The corresponding program instructions may include instructions for the robot 70 and/or the precise measurement device 74. As such, the processor of the machine tool 72 can communicate with the robot 70 to instruct the robot 70 during operations of loading and unloading the stock and transfer of the modified stock to and/or from the precise measurement device 74. Program instructions may also be communicated from the machine tool 72 to the precise measurement device 74 to indicate the specifications for the corresponding job identifier so that the precise measurement device 74 is aware of the types of measurements to be made and the corresponding specifications for the measurements. In an exemplary embodiment, the open architecture of the network 32 coupled with the API of the first processor 22 may enable an operator to, for example, utilize an automatic correction function for data manipulation and machine offset. In this regard, the communication between the machine tool 72, the robot 70 and the precise measurement device 74 may enable a software application to direct an automatic re-feeding of a machined part from the precise measurement device 74 back to the machine tool 72 in response to an out of specification measurement at the precise measurement device 74. In an exemplary embodiment, an on screen display may include a button or icon, which when selected enables the automatic correction function described above.

In one exemplary embodiment, control of the robot 70 may be enabled at the machine tool 72. Thus, robot 70 operations may be conducted via the network 32 at a location remote from the robot 70. The control may be, for example, a PC based control operated at a user interface (e.g., the interface element 52) of the machine tool 72.

As described above, the connection between the machine tool 72 and the robot 70 may be performed via, for example, a device network bridge such as, for example, an Anybus® DeviceNet bridge enabling instant recognition of the robot 70 by the machine tool 72. In other words, the machine tool 72 can automatically identify and commence communication with the robot 70 when a connection is established between the robot 70 and the machine tool 72. Such capability exists because the machine tool controller (e.g., the first controller 22) may include information that is stored in advance either at the machine tool controller or in a location accessible by the machine tool controller (e.g., the storage device 54) so that the machine tool controller can identify the robot 70 and institute measures for enabling communication with the robot 70. The machine tool controller and the controller of the robot 70 share a standard protocol and thus information regarding communication, operation and reporting may be accomplished between the robot 70 and the machine tool 72 using a common or standard set of software tools. As such, the machine tool 72 may receive a status indication regarding the robot 70 such as a status web page shown in FIG. 2. Accordingly, the machine tool 72 may access robot parameters for remote modification during setup and/or access robot diagnostics directly at the machine tool 72 (e.g., via Ethernet) for problem resolution and maintenance during operation. Thus, for example, if the robot 70 trips an alarm based on a particular condition, a user of the machine tool 72 may receive an indication of robot status, including a reason for the alarm, at the machine tool controller, thereby potentially eliminating any requirement for the user to walk over to the robot 70 to check the robot's status. Such a feature may allow remote monitoring of devices, such that, for example, a cage surrounding the devices for safety purposed, may not need to be entered. Because, in many environments, entering the case shuts down the devices, device downtime may be reduced.

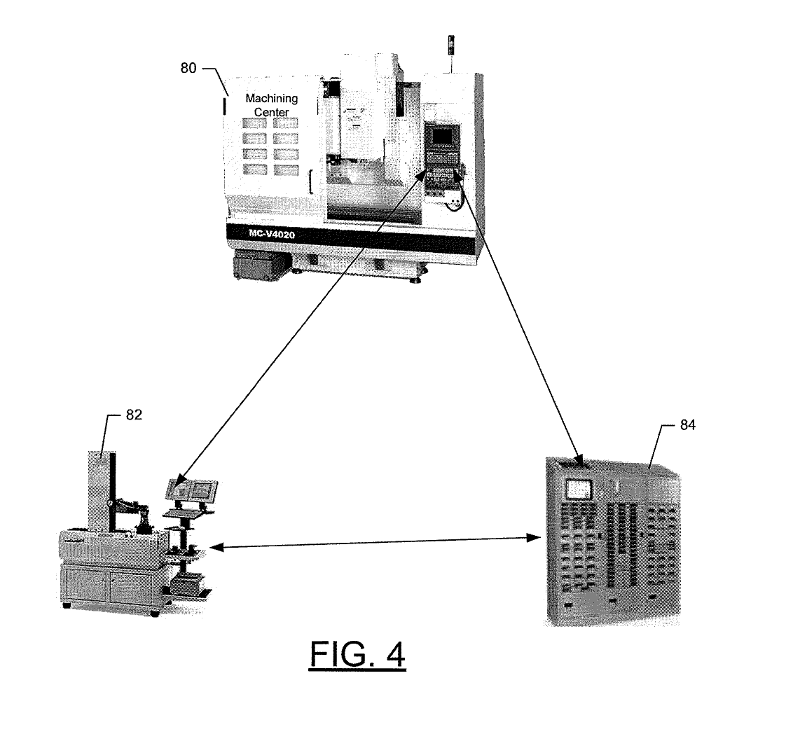

FIG. 4 illustrates a similar operation to that described with respect to FIG. 3 above involving the establishment of communication between different devices such as a tool assembler (or machining center), a tool inventory management system and a tool presetter. In the example shown in FIG. 4, communications may be established as described above, in order to enable coordination of efforts and communication of information related to assembly, presetting and use of a particular tool. As such, communication between each of the devices may be conducted to share program information for a particular job identifier (which could, for example, be acquired via a barcode scan at any one of the devices) between each of the devices. Thus, for example, the tool assembly requirements could be input into the tool presetter based on a job identifier. The job identifier and a tool request may be communicated to the tool inventory management system, which then releases the tool components from inventory that correspond to the job identifier for presetting. The tool components may be preset at the tool presetter and, based on the scanned job identifier at the tool assembler, assembly of the tool may then be accomplished subsequent to communication between the tool assembler and both the tool presetter and the tool inventory management system. In an exemplary embodiment, communication may include tool offset and tool life data request information. Accordingly, for example, tool offset information as determined by the tool presetter can be fed to the machine tool to provide more precise machining.

Referring now to FIG. 4, a machining center 80 (e.g., machine tool) may correspond to the first device 12 and a tool presetter 82 and tool inventory management device 84 may correspond to the second device 14 and third device 16, respectively. Each of the machining center 80, the tool presetter 82 and the tool inventory management device 84 may be manufactured by different entities and may otherwise be operable independently of one another. However, in accordance with embodiments of the present invention, due to the open architecture of the API of a controller, for example, of the machining center 80, manufacturers of the tool presetter 82 and/or the tool inventory management device 84 may separately develop applications that enable plug 'n play operation of their corresponding devices with the machining center 80. As such, upon initiating communication with the machining center 80, applications associated with either or both of the tool presetter 82 and the tool inventory management device 84 may be executed at the machining center 80 thereby creating a level of interoperability and convenience for the user that has heretofore been unknown. In this regard, for example, a tool assembly job may be identified (e.g., via the scanned job identifier) at the machining center 80 and the corresponding tool and/or components may be identified and released from the tool inventory management device 84. The tool presetter 82 may have the corresponding presetting and/or measurement parameters available to preset the tool based also on the scanned job identifier and, once presetting is complete, the corresponding job may be machined at the machining center 80. At any point, if feedback is required from one device to another with regard to the job, such feedback may be supplied and corresponding actions may be directed based on instructions associated with the feedback.

Additional examples will now be described in reference to the utilization of communication establishment between various tools, which enables, among other things, a controller at one device to perform job setup for multiple devices and also may enable control of multiple devices from the controller of a single device based on program instructions, for example, associated with a particular job identifier. Diagnosis of problems and monitoring of operational parameters may also be performed for multiple devices at a single device controller. In an exemplary embodiment, if a problem at a device such as a barfeeder (e.g., the second device 14) feeding a machine tool (e.g., the first device 12) is detected at the machine tool, the machine tool controller may display an indication of the detected problem on a display and provide the user with a link (e.g., via a web page displayed), the selection of which may access an application for assisting the user in determining the reason for the problem or directions for analyzing the cause of the problem and/or clearing the problem and recommencing operations. The barfeeder may also receive part information such as part length, directly from the machine tool. Additionally, the system 10 may be employed in the context of a machine tool used in combination with precision gauges or other precision measuring devices in order to significantly reduce the reliance on dedicated proprietary interface devices and/or devices from third parties.

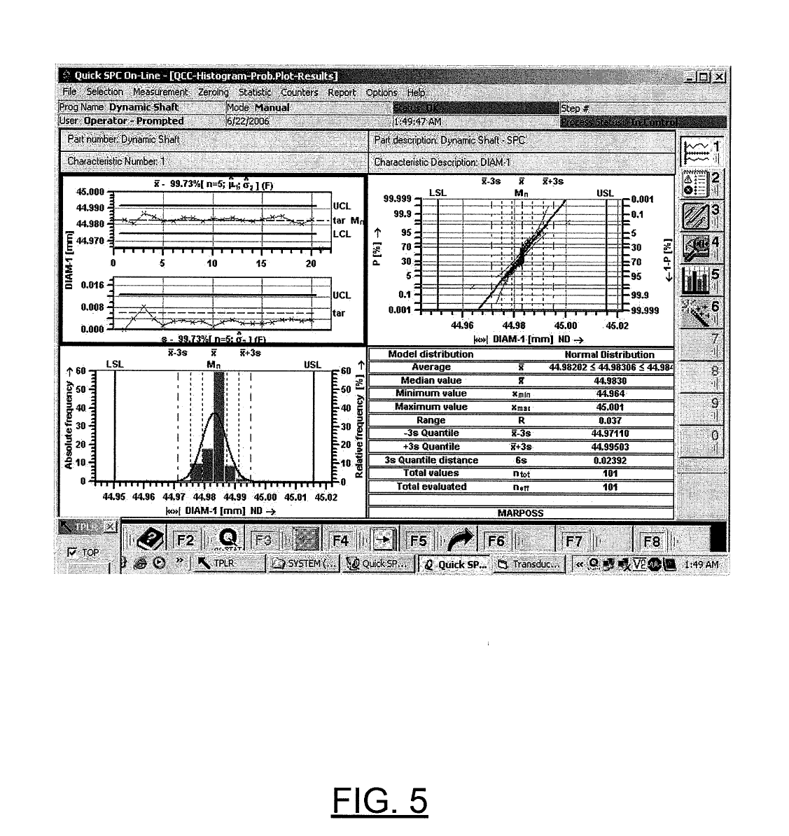

In this regard, for example, a machine tool may be linked with, for example, a quickset gauge enabling direct tool compensation via the execution of software associated with the gauge for processing gauge data and determining compensation parameters, which may be communicated to the machine tool. In this regard, for example, FIG. 5 illustrates a display interface which may be rendered at a display of the machine tool via communication with the gauge to show an exemplary online and real time enablement of direct tool compensation. As shown in FIG. 5, histograms, tolerance trends and/or compensation requirements may be communicated and presented in an application interface similar to a common Windows application interface. In an exemplary embodiment, laser gauging, computer assisted design (CAD) modeling for tool adjustments, and other measurement and verification devices may be integrated with, for example, a machine tool via plug 'n play interaction over the network 32. In this regard, programs or applications associated with various different devices may be downloaded to and run at the controller of the machine tool via the open architecture API. Accordingly, real time, adaptive control may be provided at the machine tool for each of various devices employed with the machine tool.

In another exemplary embodiment, the second device 14 could be a chip blaster. As such, the chip blaster may be in communication with the machine tool (e.g., the first device 12) via the network 32. The machine tool may execute an application for controlling chip blaster operating pressure, for example, via a display of the machine tool that may give variable tool pressure choices to the operator. For given tools, different pressures may be desired. Accordingly, for example, based on a job identifier or a particular tool, an operator may utilize the user interface of the machine tool to set the pressure of the chip blaster.

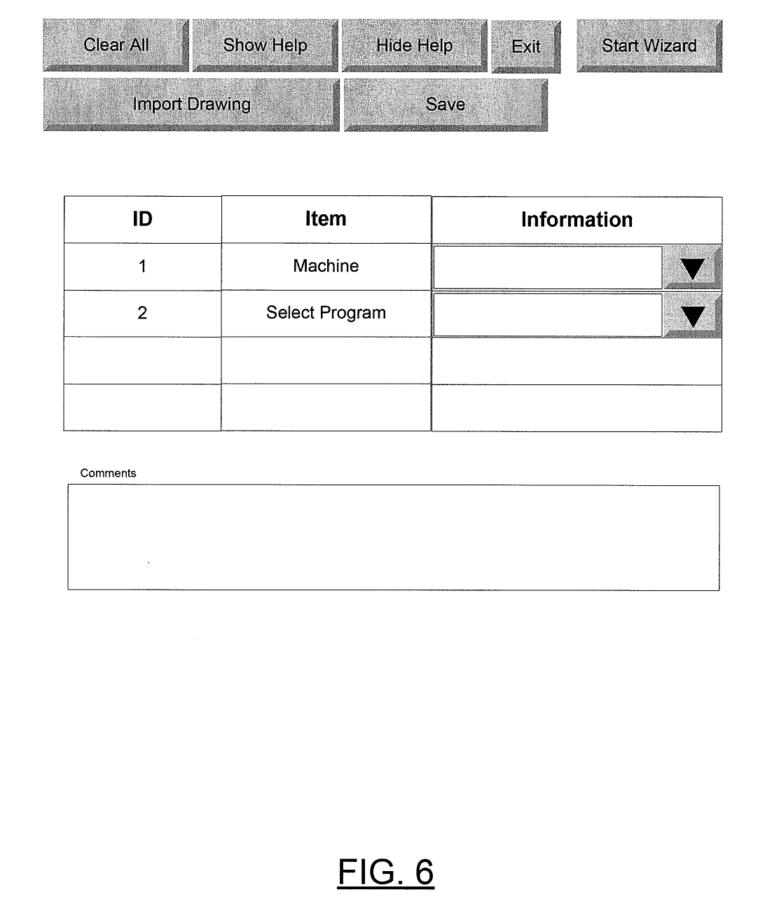

In light of the descriptions above, it may be clear to one of skill in the art that numerous applications (e.g., the application 30) could be performed, for example, at the first controller 22 for managing and improving a production process involving numerous devices. According to one exemplary embodiment, the application 30 may be a one touch spread sheet application or setup wizard application as shown in FIG. 6. In an exemplary embodiment, the one touch spread sheet application may be configured to employ Microsoft Excel, however, other applications may also be employed. The one touch spread sheet application provides a single application accessible, for example, via selection of a corresponding icon, which steps an operator through a setup procedure for a particular device such as a machine tool to enable the operator to configure the application to measure data, store data, report quality, etc. for a particular job or program. In an exemplary embodiment, the one touch spread sheet application includes a series of information and control console (ICC) screens having fields for receiving information which may correspond to particular functions which may be performed via the one touch spread sheet application.

For example, an ICC may be provided to enable the user to select a type of machine, a program name, or a job identifier. In an exemplary embodiment, the one touch spread sheet application may be directed to generate (e.g., print) a barcode corresponding to a particular job identifier. The one touch spread sheet application may include a field for receiving a drawing which may be imported. Other fields may also exist for receiving additional information or notes. For example, fields may be provided to receive offset measurements, tolerance information, specifications related to particular parts, drawing data, etc. The drawing data may include information which may be added to an imported drawing such as measurement data, inspection requirements, tolerance values or other specification data. The ICC may also provide a save function to enable saving of any changes made to a particular job identifier's setup. In an exemplary embodiment, the one touch spread sheet application also provides a common variables page.

In an exemplary embodiment, control of a shop floor process may be managed remotely (e.g., at the management console 60) in order to conduct ERP management. In this regard, for example, a job may be defined including a description, a listing of tools, materials, machines, etc. needed for the job, estimated time and cost, and/or other job features. In one embodiment, the job may be stored in association with a particular job identifier. A job may be assigned from the management console 60 to a particular worker or device. Via communication over the network 32, corresponding devices and/or workers may be informed of the assignment and automatic tracking and/or reporting of job progress and statistics may automatically be communicated to the management console 60. Accordingly, accurate reporting with regard to machine start/stop times, output, errors, material and tool usage, etc. may be recorded without need for paper or additional effort. Such a mechanism may be useful for direct labor billing and other automated tracking mechanisms since each worker may login to perform functions and thereby be tracked in the performance of such functions.

According to another exemplary embodiment, the application 30 may be a real time adaptive control application. As such, the application 30 may include a real time adaptive control element configured to monitor conditions such as operating parameters or other measurements associated with devices involved in a particular job or program. Thus, for example, the application 30 may receive reports of data such as current drawn, vibrations, frequency data, etc. in order to monitor and report on operational conditions. In an exemplary embodiment, the application 30 may analyze data received locally (i.e., at the controller of the associated device) which could be used to determine, for example, if operating conditions could damage equipment or products, or even if a shutdown is imminent. Utilizing applications such as the real time adaptive control application and others described herein, a paperless factory floor may be achieved since, for example, monitoring may be accomplished via digital data logging and file transfers rather than printing paper copies of logs, etc. In an exemplary embodiment, horsepower of a machine tool may be monitored to establish a baseline operating horsepower. Then, during operation, the machine tool may be controlled by increasing or decreasing speed as necessary to maintain a desired horsepower throughout a machining process.

As may be appreciated from the preceding, embodiments of the present invention may be utilized to establish plug 'n play operation and improved device integration with respect to numerous devices. Although several such devices have been listed above, and yet further devices will be described below, it should be understood that the devices described herein are provided for exemplary purposes and not for purposes of limitation. Various applications may be developed for use in connection with device integration according to exemplary embodiments. In this regard, according to one exemplary embodiment, the application 30 may be a tool inventory and data management application. For example, an off-the-shelf handheld device such as a Symbol Technologies Handheld PC may be utilized for tool identification with a wireless LAN and a barcode reader to replace a conventional tool management system which includes data regarding each tool stored on a chip. Alternatively, instead of a barcode, an RFID or any other suitable identification mechanism may be employed. As such, the handheld PC may be employed to read and/or write information at the chip and then communicate via a wireless router and an Ethernet connection with any device on a network.

According to another exemplary embodiment, the application 30 may be a system protection application for use in conjunction with the system protect monitoring console 62. For example, the system protect monitoring console 62 may receive operational status information such as operating parameters for storage and analysis as described in greater detail below. The operational status information may include, for example, device operating parameters (e.g., current, voltage, frequency, speed of rotation, vibration, etc.) or environmental parameters (e.g., temperature, humidity, etc.). The operational status information may be communicated to the system protect monitoring console 62 by any controller of a device employing the application 30, or by the management console 60. Accordingly, the system protect monitoring console 62 collects data corresponding to a particular device on the network and indicative of the operation of the particular device. It should be noted that although the system protect monitoring console 62 is shown in FIG. 1 as being in communication with the network 32 via the cellular communication network 40, the system protect monitoring console 62 could also be in communication with the network 32 via any other suitable communication link such as, for example, via the satellite network 38, the Internet 36, etc. However, it should be noted that regardless of the type of communication link used, embodiments of the present invention may employ encryption at both the devices (or at a network gateway) and at the system protect monitoring console 62 to ensure that any data and/or troubleshooting information shared between the devices and the system protect monitoring console 62 are securely protected from access to unwanted parties.

In an exemplary embodiment, the system protect monitoring console 62 may receive the collected data on either a continuous or event driven basis. For example, events such as startup, automatic shutdown, overspeed, overcurrent, etc. related to a particular device may trigger data collection. Alternatively, the event may be a user request. Thus, for example, in one embodiment the system protect monitoring console 62 may continuously monitor device operation, while in another embodiment the system protect monitoring console 62 may only be enabled to monitor device operation when enabled or requested by the user of the device. The application 30 may then utilize statistical modeling or historical data to analyze the particular data that has been collected in light of the historical data or statistical model to determine, for example, a most likely mode of failure and an expected time to failure. The application 30 could also simply predict future problems that do not reach the level of a failure. Alternatively, the application 30 may analyze the collected data and, based on the historical data or statistical model, determine a most likely cause for an existing failure or problem.

According to an exemplary embodiment, an operator in communication with the system protect monitoring console 62 at an external facility may contact the user by phone, or be contacted by the user in order to discuss an existing failure or problem in order to provide assistance to the user in troubleshooting the failure or problem based on the remotely monitored and collected data. As such, the operator may assist in troubleshooting and provide an industry standard backup and recovery solution which may exist for the particular failure or problem. The system protect monitoring console 62 may employ a plurality of resources to which the user may not otherwise have access. For example, the system protect monitoring console 62 may include a virus clean up module, a backup and recovery module, update modules, a remote troubleshooting module and a predictive analysis module all of which may be commercially available modules whose resources are concentrated at a single access point for utilization by users and/or the operator to assist the users in monitoring equipment accurately with a secure and reliable protection service.

In another exemplary embodiment, the user may utilize the communication element 50 to conduct an online chat session with the operator for troubleshooting assistance. In yet another exemplary embodiment, the application 30 may provide the user with, for example, an icon, the selection of which may activate a support session with the operator. Alternatively, selection of the icon may initiate an online troubleshooting session in which web pages detailing troubleshooting paths may be accessed corresponding to different fault trees.

In another exemplary embodiment, the application 30 may be a part cost accounting application. The part cost accounting application may enable the accurate determination of calculation of cost per part number since the part cost accounting application monitors device output at a particular device in order to determine actual numbers of parts meeting and/or failing to meet specific quality guidelines. Accordingly, for example, an exact number of scrap parts produced may be determined and a corresponding number of premachined parts may be ordered.

In still another exemplary embodiment, the application 30 may be a precision measuring application employing a camera for measurement. In this regard, each device may include a camera for capturing high resolution images of parts, tolerances, or any area in which measurements are desired. Upon analyzing the image, accurate measurements may be made based, for example, on a number of pixels that a particular feature extends over at a given distance from the camera. Additionally, image processing techniques such as compression, encoding and decoding techniques may be employed in order to create images that are easily transmittable to potential purchasers, or engineers to enable remote evaluation of product quality.

In yet another exemplary embodiment, the application 30 may be a voice recognition application. As such, the voice recognition application may be configured to resolve voice commands in noisy environments in order to enable users to perform certain functions or issue certain commands to a device without actually being proximate to the device or at least without being in physical contact with the device. Additionally, or alternatively, the voice recognition application could provide audible feedback to the user instead of or in addition to text feedback.

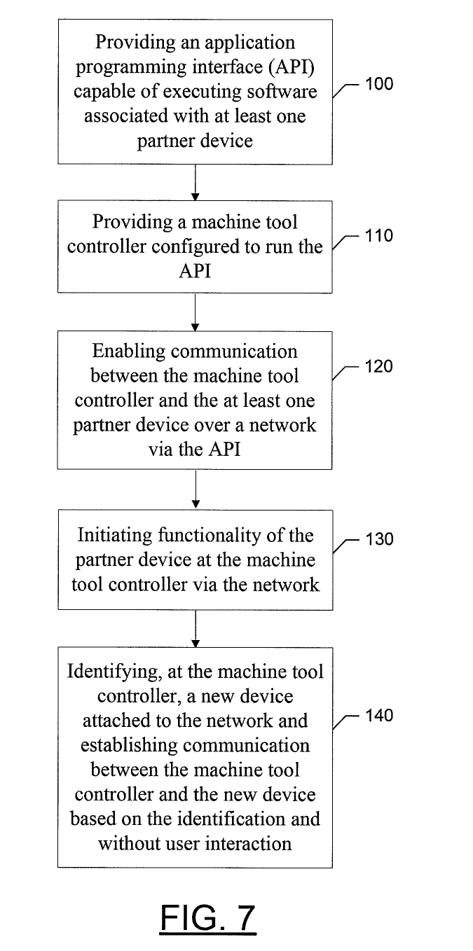

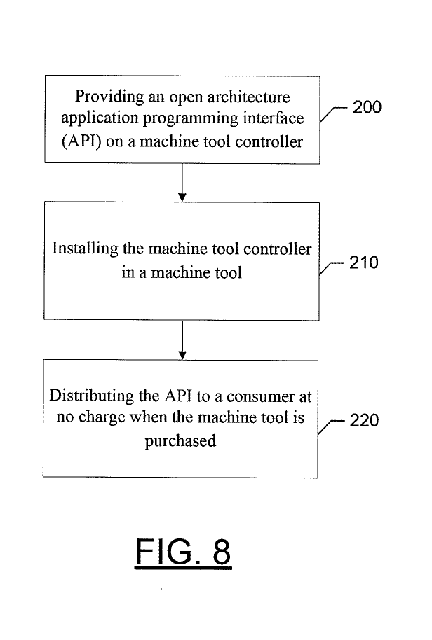

FIGS. 7 and 8 are flowcharts of a system, methods and program products according to exemplary embodiments of the invention. It will be understood that each block or step of the flowcharts, and combinations of blocks in the flowcharts, can be implemented by various means, such as hardware, firmware, and/or software including one or more computer program instructions. For example, blocks of the flowcharts may be embodied by computer program instructions. In this regard, for example, the computer program instructions which embody the procedures described herein may be stored by the storage device 54 of the first device 12 and executed by the processing element 56. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing a machine tool controller capable of “plug 'n play” operation with partner devices, as shown in FIG. 1, may include providing the application programming interface (API) capable of executing software providing an application programming interface (API) capable of executing or otherwise communicating with software associated with at least one partner device at operation 100. At operation 110, a machine tool controller configured to run the API may be provided. Communication between the machine tool controller and the at least one partner device may be enabled over a network enabled by the API at operation 120. The communication could be enabled via either an Ethernet connection or a wireless connection (e.g., Bluetooth). In one example, enabling communication may include assigning an internet protocol (IP) address to the machine tool controller and the at least on partner device.

In an exemplary embodiment, the method may include further optional operations. For example, the method may include initiating functionality of the partner device at the machine tool controller via the network at operation 130 or identifying, at the machine tool controller, a new device attached to the network and establishing communication between the machine tool controller and the new device based on the identification and without user interaction at operation 140. If operation 140 is practiced, the method may further include displaying, at a display associated with the machine tool controller, an information and control console associated with the identified new device.

In an exemplary embodiment, communication may be enabled between the machine tool controller and, for example, a barfeeder, a precise measurement tool, a tool presetter, a tool inventory management device, a chip blaster, a robot, a chip blaster, a precision gauge, or a laser gauge. The machine tool controller may include a communication element configured to translate between dissimilar protocols or formats of the machine tool controller and the at least one partner device. In an exemplary embodiment, the API may be also executable at a management console. Accordingly, the method may further include assigning a task to the machine tool controller or the at least one partner device at the management console via the network, and tracking data related to the assigned task at the management console via the network. In another exemplary embodiment, the method may further include monitoring operational parameters of the machine tool controller or the at least one partner device via the network, and directing operational control over the machine tool controller or the at least one partner device based on the monitoring via the network.

In another exemplary embodiment, the method may include providing a job identification mechanism in communication with the machine tool controller, the job identification mechanism being configured to determine a job identifier, and coordinating the functionality of the machine tool controller and the at least one partner device based on corresponding instructions associated with the job identifier. The job identification mechanism may be a barcode reader or a radio frequency identification (RFID) tag reader in communication with the machine tool controller.

In another exemplary embodiment, as shown in FIG. 8, a business method is provided. The method includes providing an open architecture application programming interface (API) on a machine tool controller at operation 200. At operation 210, the machine tool controller is installed in a machine tool. At operation 220, the API is distributed to a consumer at no charge when the machine tool is purchased.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for providing a machine tool controller capable of “plug 'n play” operation with partner devices, the method comprising:
providing an application programming interface (API) capable of communicating with software associated with at least one partner device; and
providing a machine tool controller configured to run the API; and
enabling communication between the machine tool controller and the at least one partner device over a network enabled by the API.

2. The method of claim 1, wherein enabling communication comprises establishing communication between devices via an Ethernet connection.

3. The method of claim 1, wherein enabling communication comprises establishing communication between devices via a wireless connection.

4. The method of claim 1, further comprising initiating functionality of the partner device at the machine tool controller via the network.

5. The method of claim 1, further comprising identifying, at the machine tool controller, a new device attached to the network and establishing communication between the machine tool controller and the new device based on the identification and without user interaction.

6. The method of claim 5, further comprising displaying, at a display associated with the machine tool controller, an information and control console associated with the identified new device.

7. The method of claim 1, wherein providing the API further comprises providing a communication element configured to translate between dissimilar protocols or formats of the machine tool controller and the at least one partner device.

8. The method of claim 1, wherein enabling communication between the machine tool controller and the at least one partner device comprises enabling communication between the machine tool controller and a barfeeder, a precise measurement tool, a tool presetter, a tool inventory management device, a robot, a chip blaster, a precision gauge, or a laser gauge.

9. The method of claim 1, wherein the API is executable at a management console and the method further comprises:
assigning a task to the machine tool controller or the at least one partner device at the management console via the network; and
tracking data related to the assigned task at the management console via the network.

10. The method of claim 9, further comprising:
monitoring operational parameters of the machine tool controller or the at least one partner device via the network; and
directing operational control over the machine tool controller or the at least one partner device based on the monitoring via the network.

11. The method of claim 1, wherein enabling communication between the machine tool controller and the at least one partner device over the network comprises assigning an internet protocol (IP) address to the machine tool controller and the at least one partner device.

12. The method of claim 1, further comprising:
providing a job identification mechanism in communication with the machine tool controller, the job identification mechanism being configured to determine a job identifier; and
coordinating the functionality of the machine tool controller and the at least one partner device based on corresponding instructions associated with the job identifier.

13. The method of claim 12, wherein providing the job identification mechanism comprises placing a barcode reader or a radio frequency identification (RFID) tag reader in communication with the machine tool controller.

14. A computer program product for providing a machine tool controller capable of “plug 'n play” operation with partner devices, the computer program product comprising at least one computer-readable storage medium having computer-readable program code portions stored therein, the computer-readable program code portions comprising:
a first executable portion for providing an application programming interface (API) associated with at least one partner device; and
a second executable portion for providing a machine tool controller configured to run the API; and
a third executable portion for enabling communication between the machine tool controller and the at least one partner device over a network enabled by the API.

15. The computer program product of claim 14, wherein the third executable portion includes instructions for establishing communication between devices via an Ethernet connection.

16. The computer program product of claim 14, wherein the third executable portion includes instructions for establishing communication between devices via a wireless connection.

17. The computer program product of claim 14, further comprising a fourth executable portion for initiating functionality of the partner device at the machine tool controller via the network.

18. The computer program product of claim 14, further comprising a fourth executable portion for identifying, at the machine tool controller, a new device attached to the network and establishing communication between the machine tool controller and the new device based on the identification and without user interaction.

19. The computer program product of claim 14, wherein the API is executable at a management console and the computer program product further comprises:
a fourth executable portion for assigning a task to the machine tool controller or the at least one partner device at the management console via the network; and
a fifth executable portion for tracking data related to the assigned task at the management console via the network.

20. The computer program product of claim 14, wherein the third executable portion includes instructions for assigning an internet protocol (IP) address to the machine tool controller and the at least one partner device.

21. A business method comprising:
providing an open architecture application programming interface (API) on a machine tool controller;
installing the machine tool controller in a machine tool; and
distributing the API to a consumer at no charge when the machine tool is purchased.

22. The method of claim 21, further comprising enabling the development and execution of applications associated with a partner device placed in communication with the machine tool to be performed via a network using the API.

23. The method of claim 21, further comprising providing a management console configured to enable the remote control and tracking of operations performed at a partner device placed in communication with the machine tool and at the machine tool via a network using the API.

24. A machine tool comprising a machine tool controller capable of “plug 'n play” operation with partner devices, the machine tool controller comprising a processing element configured to:
provide an application programming interface (API) capable of communicating with software associated with at least one partner device; and
provide a machine tool controller configured to run the API; and
enable communication between the machine tool controller and the at least one partner device over a network enabled by the API.

25. The machine tool of claim 24, wherein the processing element is further configured to:
provide a job identification mechanism in communication with the machine tool controller, the job identification mechanism being configured to determine a job identifier; and
coordinate the functionality of the machine tool controller and the at least one partner device based on corresponding instructions associated with the job identifier.
